(19) United States
(12) Patent Application Publication
(10) Pub. No.: US 2012/0262579 A1
(43) Pub. Date: Oct. 18, 2012

(54) ELECTRONIC DEVICE AND VEHICLE DETECTION METHOD USING THE ELECTRONIC DEVICE

(75) Inventors: CHIEN-LIN CHEN, Tu-Cheng (TW); LUNG-CHI LEE, Tu-Cheng (TW)

(73) Assignee: HON HAI PRECISION INDUSTRY CO., LTD., Tu-Cheng (TW)

(21) Appl. No.: 13/410,295

(22) Filed: Mar. 2, 2012

(30) Foreign Application Priority Data
Apr. 15, 2011 (TW) 100113301

(51) Int. Cl. H04N 7/18

(52) U.S. Cl. 348/148; 348/E07.085

(57) ABSTRACT

A vehicle detection method is implemented by an electronic device. The electronic device controls at least one image capture device to capture images of a road intersection governed by a traffic light, and to capture data as to vehicles using the road intersection. The traffic light includes at least one of a red light and a green light. By analyzing the images and vehicle data, the electronic device detects and identifies a vehicle illegally crossing the road intersection.

### BACKGROUND

1. Technical Field

Embodiments of the present disclosure generally relate to traffic detection devices and methods, and particularly to an electronic device and a vehicle detection method using the electronic device.

2. Description of Related Art

Traffic law enforcement by camera uses 35 mm film-based cameras for the detection of speed and red-light violations. In the case of red light violations, the question of whether a vehicle moves illegally across a stop line of a road intersection is hard to detect. Therefore, it is desirable to have a vehicle detection method to overcome the above-mentioned problem.

### BRIEF DESCRIPTION OF THE DRAWINGS

FIG. 1 is a block diagram of one embodiment of an electronic device including a vehicle detection unit.

FIG. 2 is a block diagram of one embodiment of function modules of the vehicle detection unit of FIG. 1.

FIG. 3 is a flowchart illustrating one embodiment of a vehicle detection method.

FIG. 4 is a detailed description of block S02 in FIG. 3, for detecting whether a traffic light displays a red light.

FIG. 5 is a schematic diagram illustrating a road intersection having a traffic light and an image capture device positioned.

FIG. 6 including FIG. 6A and FIG. 6B gives an example of a traffic light.

FIG. 7 is a block diagram of one embodiment of a system for vehicle detection.

### DETAILED DESCRIPTION

In general, the word “module,” as used herein, refers to logic embodied in hardware or firmware, or to a collection of software instructions, written in a programming language, such as, for example, Java, C, or assembly. One or more software instructions in the modules may be embedded in firmware, such as in an EPROM. Modules may comprise connected logic units, such as gates and flip-flops, and may comprise programmable units, such as programmable gate arrays or processors. The modules described herein may be implemented as either software and/or hardware modules and may be stored in any type of computer-readable medium or other computer storage device.

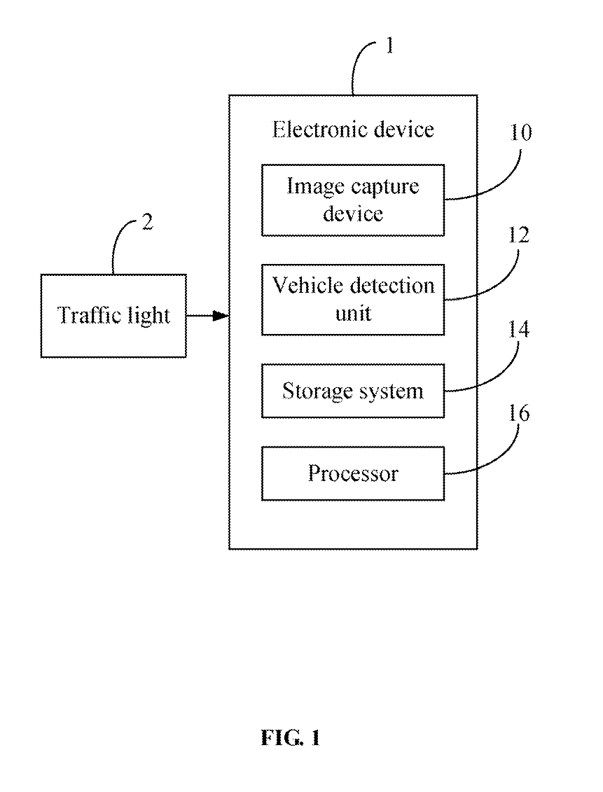

FIG. 1 is a block diagram of one embodiment of an electronic device 1 including a vehicle detection unit 12. The electronic device 1 further includes a storage system 14, and at least one processor 16. In the embodiment, the electronic device 1 is in electronic communication with at least one traffic light 2 located at one or more road intersections of roadways. The vehicle detection unit 12 may be a software program stored in the storage system 14 and executed by the processor 16. The vehicle detection unit 12 can control at least one image capture device 10 to capture vehicle data of the road intersection including an image of the traffic light 2. By analyzing the vehicle data, the vehicle detection unit 12 can detect a vehicle that crosses or attempts to cross the road intersection illegally.

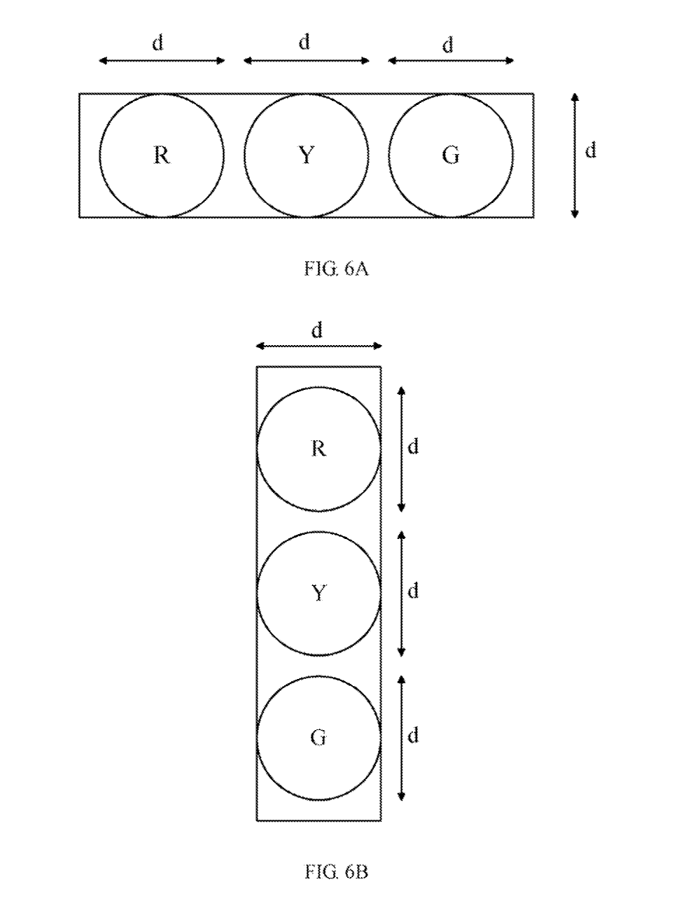

In one embodiment, the electronic device 1 may be a computer, a TV, a portable electronic device, or any other electronic device that includes the storage system 14 and the at least one processor 16. In one embodiment, the traffic light 2 may have LED illumination units (not shown) for emitting light, and uses different LED illumination units for different signals, such as a red signal and a green signal. In another embodiment, the traffic light 2 may have three LED illumination units for different lights as signals, which include red, green, and yellow or amber. As shown in FIG. 6A, the housings (not marked) containing the LED illumination units for red, yellow and green are arranged horizontally in the traffic light 2. FIG. 6B shows the housings for the red light (R), the yellow light (Y) and the green light (G) arranged vertically in the traffic light 2.

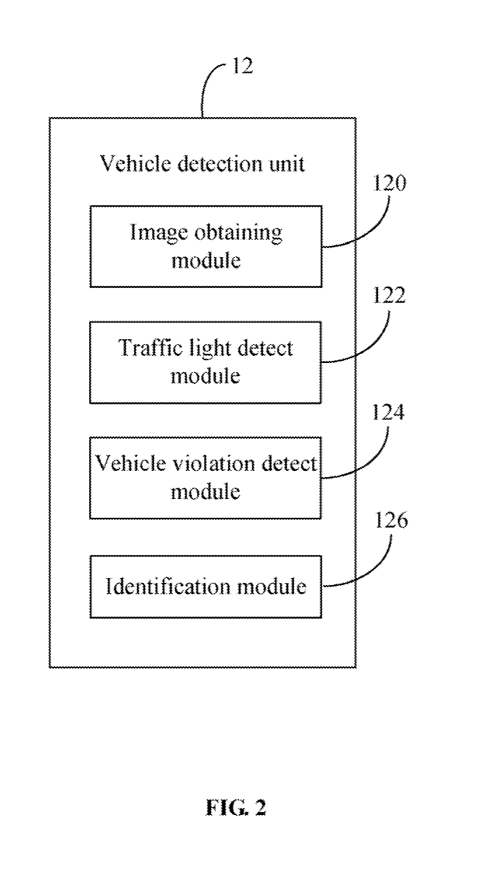

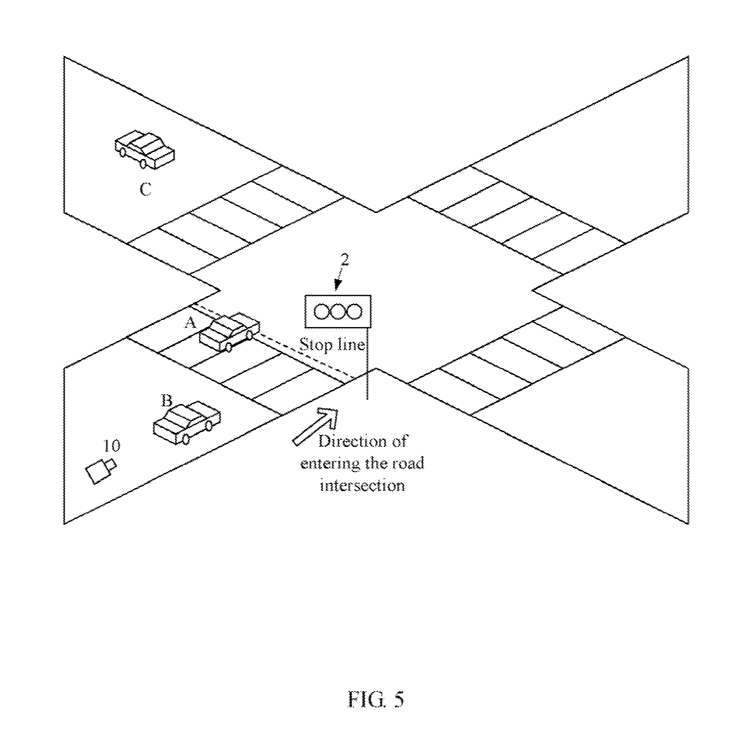

FIG. 5 is a schematic diagram illustrating a road intersection having a traffic light 2 and an image capture device 10 positioned. In FIG. 5, the image capture device 10 is installed on a tall object such as a pole. The image capture device 10 captures an oncoming view of the traffic light 2, and can capture images of the traffic light 2 and monitor traffic conditions of the road intersection. When the traffic light 2 displays the red light, the image capture device 10 captures an image of the traffic light 2 at short intervals of time. The vehicle detection unit 12 obtains the image, and detects whether any vehicle pasts a stop line of the road intersection by analyzing the image. In one embodiment, “past a stop line” means that just the front two tires of a vehicle are across the stop line. For example in FIG. 5, the vehicle detection unit 12 may detect that a car “A” pasts the stop line when the traffic light 2 displays a red light. The detailed functions of the vehicle detection unit 12 are described below with reference to FIGS. 2 to 7.

FIG. 2 is a block diagram of one embodiment of function modules of the vehicle detection unit 12 of FIG. 1. In one embodiment, the vehicle detection unit 12 includes an image obtaining module 120, a traffic light detect module 122, a vehicle violation detect module 124, and an identification module 126. Each of the modules 120-126 may be a software program including one or more computerized instructions that are stored in the storage system 14 and executed by the processor 16.

The image obtaining module 120 controls the at least one image capture device 10 (only one image capture device 10 shown in FIG. 1) to capture vehicle data of the road intersection including, or in addition to, an image of the traffic light 2 at the road intersection.

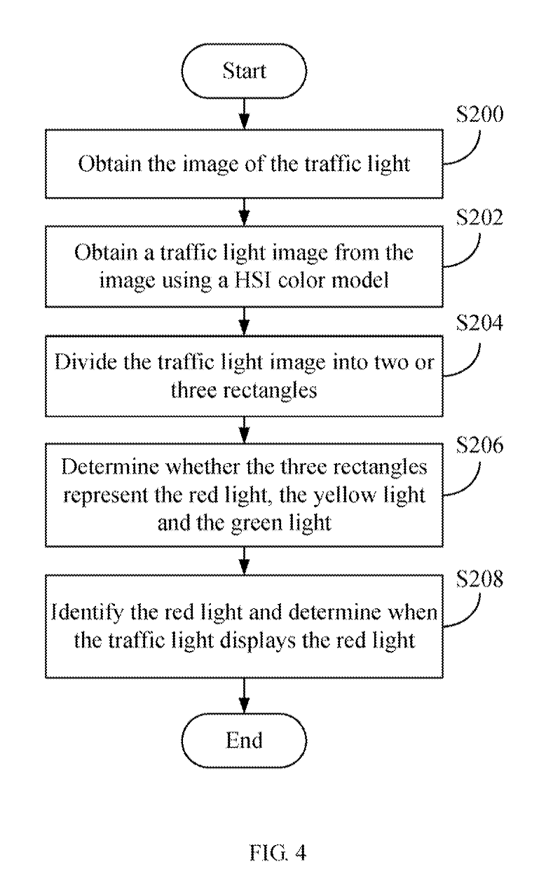

The traffic light detect module 122 detects whether the traffic light 2 displays a red light by analyzing the image. Details of detection of the traffic are described in FIG. 4.

When the traffic light 2 displays the red light, the vehicle violation detect module 124 uses a mobile object detection algorithm to detect whether a vehicle pasts the stop line (such as the stop line in FIG. 5) of the road intersection, based on the vehicle data. If any vehicle pasts the stop line at a time when the traffic light 2 displays the red light, the vehicle violation detect module 124 determines that such a vehicle is in violation of traffic laws. In one embodiment, the mobile object detection algorithm may be a background subtraction algorithm, an optical flow algorithm, or a temporal differencing algorithm, for example.

For example, the vehicle violation detect module 124 may set the stop line as a boundary for traffic violation purposes, and detects the particular point or position of a vehicle on the roadway according to the vehicle data. If the mobile object is at the particular point, the vehicle violation detect module 124 detects whether a moving direction of the mobile object is a direction of entering the road intersection. Upon the condition that the direction of the mobile object is the direction of entering the road intersection, the vehicle violation detect module 124 also determines whether an image area of the mobile object meets a size of a vehicle such as a car or truck. If the image area of the mobile object does meet or suggest the size of a vehicle, the vehicle violation detect module 124 will determine that the mobile object may be an offending vehicle.

Subject to a determination that the vehicle pasts the stop line, the identification module 126 identifies the license number of the vehicle from the vehicle data, and records the license number in the storage system 14 of the electronic device.

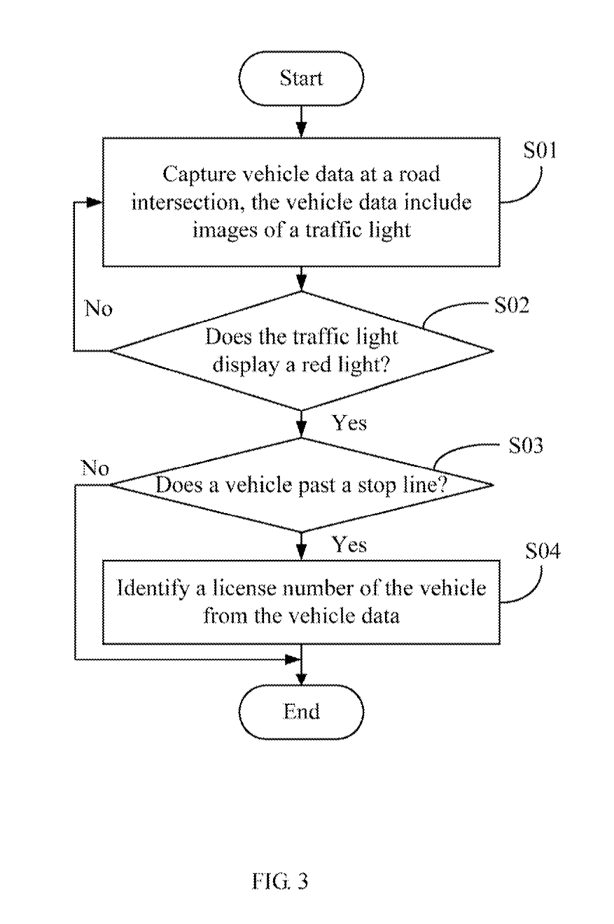

FIG. 3 is a flowchart illustrating one embodiment of a vehicle detection method. Depending on the embodiment, additional blocks may be added, others removed, and the ordering of the blocks may be changed.

In step S01, the image obtaining module 120 controls the one or more image capture devices 10 to capture vehicle data at a road intersection, including or in addition to, images of the traffic light 2 at the road intersection.

In step S02, the traffic light detect module 122 detects whether the traffic light 2 displays the red light by analyzing the image(s). Details of detection of the red light are described in FIG. 4.

When the traffic light 2 displays the red light, step S03 is implemented. Until the traffic light 2 displays the red light, the flow remains in step S01.

In step S03, the vehicle violation detect module 124 uses the mobile object detection algorithm to detect whether a vehicle pasts the stop line (such as the stop line in FIG. 5) of the road intersection, based on the vehicle data. If a vehicle is deemed to be across the stop line, step S04 is implemented. If no vehicle is found to be across the stop line, the flow ends. In one embodiment, the mobile object detection algorithm may be for example a background subtraction algorithm, an optical flow algorithm, or a temporal differencing algorithm.

In step S04, the vehicle violation detect module 124 determines that the vehicle is in violation of traffic laws, the identification module 126 identifies the license number of the vehicle from the vehicle data, and records the license number in the storage system 14. In details, the identification module 126 locates a license plate of the vehicle using an AdaBoost algorithm or a connectionist model, separates an image of the license plate from the vehicle data, and identifies numeric or alphanumeric codes of the license plate from the image of the license plate.

FIG. 4 is a detailed description of block S02 in FIG. 3, for detecting whether the traffic light 2 displays a red light. Depending on the embodiment, additional blocks may be added, others removed, and the ordering of the blocks may be changed.

In step S200, the traffic light detect module 122 obtains the images of the traffic light 2 captured by the image capture device 10.

In step S202, the traffic light detect module 122 analyzes each of the images and obtains a traffic light image from the image using a Hue-Saturation-Intensity (Lightness) (HSI) color model. In detail, the traffic light detect module 122 filters out the image area that does not cover the traffic light b 2, and keeps the image area that covers the traffic light 2, namely the traffic light image.

By using the HIS color model, the traffic light detect module 122 can convert the traffic light image in RGB space into HSI space using follow formula:

$$H = {cos}^{- 1} \{ \frac{\frac{1}{2} [ ( R - G ) + ( R - B ) ]}{{[ {( R - G )}^{2} + ( R - G ) ( G - B ) ]}^{\frac{1}{2}}} \} , \\ S = 1 - \frac{3}{( R + G + B )} [ min ( R , G , B ) ] , I = \frac{1}{3} ( R + G + B )$$

In the formula, R, G and B are gray scale of the traffic light image, values of the R, G and B are in a range “0˜255.” From the formula, a range of the parameter “H” is a number of circular degrees from 0 to 360 degrees, a range of the parameter “S” is from 0 to 1, and the parameter “I” is from 0 to 255.

In step S204, the traffic light detect module 122 sets threshold values for each color of the traffic light 2, and divides the traffic light image into two or three rectangles based on the threshold value for each color of light. For example, as shown in FIG. 6A and FIG. 6B, the traffic light 2 includes three LED units: a first LED unit is for giving the red light, a second LED unit is for giving the yellow light, and a third LED unit is for giving the green light. The traffic light detect module 122 divides the traffic light image into three rectangles.

In the embodiment, the conditions for identifying the red light are:

$$\{ \begin{matrix}{H}_{R , 1} ≦ Hue ≦ {H}_{R , 2} \\ {S}_{R , 1} ≦ Saturation \\ {I}_{R , 1} ≦ Intensity\end{matrix} ,$$

H_{R,1}, H_{R,2}, S_{R,1}, and the threshold values of identifying the red light. The conditions for identifying the green light are:

$$\{ \begin{matrix}{H}_{G , 1} ≦ Hue ≦ {H}_{G , 2} \\ {S}_{G , 1} ≦ Saturation \\ {I}_{G , 1} ≦ Intensity\end{matrix} ,$$

H_{G,1}, H_{G,2}, S_{G,1}, and I_{G,1} are the threshold values of identifying the green light. The conditions for identifying the yellow light are:

$$\{ \begin{matrix}{H}_{Y , 1} ≦ Hue ≦ {H}_{Y , 2} \\ {S}_{Y , 1} ≦ Saturation \\ {I}_{Y , 1} ≦ Intensity\end{matrix} ,$$

H_{Y,1}, H_{Y,2}, S_{Y,1}, and I_{Y,1} are the threshold values of identifying the yellow light.

In step S206, the traffic light detect module 122 further determines whether the three rectangles represent the red light, the yellow light and the green light according to the juxtapositions of the pixels of the three rectangles, and the proportions of length to width of the three rectangles. In the embodiment, the number of pixels for each rectangle is larger than “θ”, the proportion of length to width of each rectangle is in a range of “lower_bound” and “upper_bound”. “θ” is a number-of-pixels threshold preset by a user, “lower_bound” and “upper_bound” are also preset by the user.

In step S208, the traffic light detect module 122 distinguishes and identifies the red light from the green light and the yellow light according to a color-changing light sequence of the traffic light 2, and determines when the traffic light displays the red light.

In the embodiment, the identification module 126 can preset a mask for identifying whether the traffic light 2 displays the red light. In the embodiment, the mask is a matrix that is composed by “1” and “0”, where “1” is used for indicating the color of light that the traffic light 2 displays, and “0” is used for indicating the color of light that the traffic light 2 does not display. For example, the identification module 126 establishes the mask according to a red light size, scans the image of the traffic light 2 according to the mask, and obtains a scan result. By comparing the scan result with a preset critical value, the identification module 126 can determine whether the traffic light 2 displays the red light.

For example, if the traffic light 2 is as shown in FIG. 6A, the mask can be preset as:

$$[ \begin{matrix}1 & 1 & 1 & 1 & 1 & 0 & 0 & 0 & 0 & 0 & 0 & 0 & 0 & 0 & 0 \\ 1 & 1 & 1 & 1 & 1 & 0 & 0 & 0 & 0 & 0 & 0 & 0 & 0 & 0 & 0 \\ 1 & 1 & 1 & 1 & 1 & 0 & 0 & 0 & 0 & 0 & 0 & 0 & 0 & 0 & 0 \\ 1 & 1 & 1 & 1 & 1 & 0 & 0 & 0 & 0 & 0 & 0 & 0 & 0 & 0 & 0 \\ 1 & 1 & 1 & 1 & 1 & 0 & 0 & 0 & 0 & 0 & 0 & 0 & 0 & 0 & 0\end{matrix} ] .$$

If the traffic light 2 is as shown in FIG. 6B, the mask can be preset as:

$$[ \begin{matrix}1 & 1 & 1 & 1 & 1 \\ 1 & 1 & 1 & 1 & 1 \\ 1 & 1 & 1 & 1 & 1 \\ 1 & 1 & 1 & 1 & 1 \\ 1 & 1 & 1 & 1 & 1 \\ 0 & 0 & 0 & 0 & 0 \\ 0 & 0 & 0 & 0 & 0 \\ 0 & 0 & 0 & 0 & 0 \\ 0 & 0 & 0 & 0 & 0 \\ 0 & 0 & 0 & 0 & 0 \\ 0 & 0 & 0 & 0 & 0 \\ 0 & 0 & 0 & 0 & 0 \\ 0 & 0 & 0 & 0 & 0 \\ 0 & 0 & 0 & 0 & 0 \\ 0 & 0 & 0 & 0 & 0\end{matrix} ] .$$

The size of the mask can be determined by an image of the red light in the traffic light image.

In another embodiment, if the traffic light 2 has two LED units, to show the red light and the green light, the method of detecting whether the traffic light 2 displays the red light is the same as the method in FIG. 4. If the traffic light 2 has only one LED unit for showing the red, green and yellow (by means of color filters or otherwise) light, the identification module 126 can detect whether the traffic light 2 displays the red light by analyzing pixel values of the traffic light image.

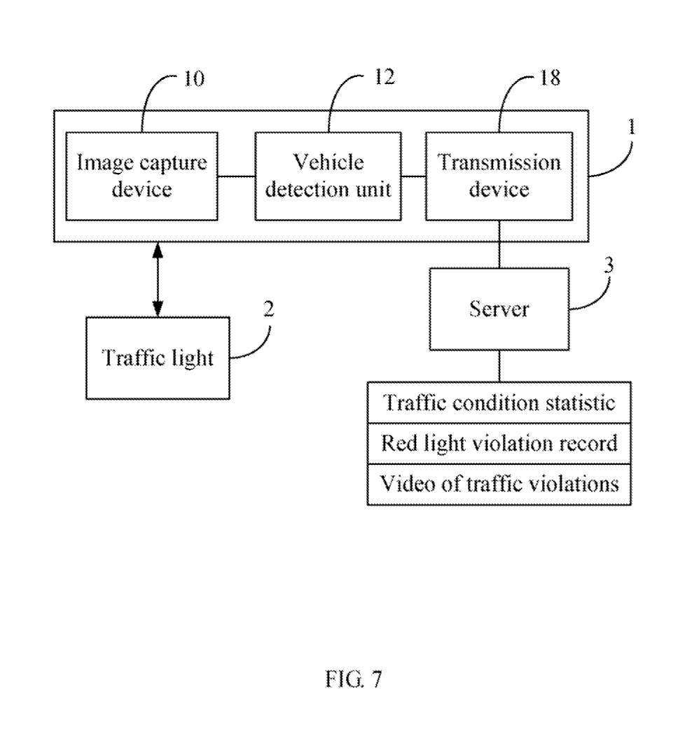

FIG. 7 is a block diagram of another embodiment of a system for vehicle detection. In FIG. 7, the electronic device 1 is a monitoring device that includes an image capture device 10, a vehicle detection unit 12, and a transmission device 18. The electronic device 1 transmits the images of the vehicle data and the traffic light 2 of the road intersection to a server 3 via the transmission device 18. The transmission device 18 can be a wired network, a WIFI protocol, a Worldwide Interoperability for Microwave Access (WIMAX) system, a Code Division Multiple Access (CDMA) transmission, or a General Packet Radio Service (GPS) protocol. The server 3 can perform a traffic condition statistic calculation, collect time-stamped traffic violations, produce video data of the traffic violations, and extract the license numbers of all offending vehicles.

Although certain inventive embodiments of the present disclosure have been specifically described, the present disclosure is not to be construed as being limited thereto. Various changes or modifications may be made to the present disclosure without departing from the scope and spirit of the present disclosure.

What is claimed is:

1. A vehicle detection method using an electronic device in electronic communication with at least one image capture device, the method comprising steps of:
controlling the at least one image capture device to capture vehicle data at a road intersection, the vehicle data comprising images of a traffic light located at the road intersection;
detecting whether the traffic light displays a red light by analyzing the images;
determining whether a vehicle pasts a stop line of the road intersection using a mobile object detection algorithm based on the vehicle data, upon the condition that the traffic light displays the red light; and
identifying a license number of the vehicle from the vehicle data, and recording the license number in a storage system of the electronic device, upon the condition that the vehicle pasts the stop line.

2. The method as described in claim 1, wherein the detecting step comprises:
(a) analyzing each of the images and obtaining a traffic light image from the images using a Hue-Saturation-Intensity color model;
(b) setting a threshold value for each color of the traffic light, and dividing the traffic light image into two or three rectangles based on the threshold value for each color of light;
(c) determining whether the two or three rectangles represent the red light, the green light and the yellow light according to juxtapositions of the pixels three rectangles and the proportions of length to width of the two or three rectangles; and
(d) upon the condition that the two or three rectangles represent the red light, the green light, and the yellow light, distinguishing and identifying the red light from the green light and the yellow light according to a color-changing light sequence of the traffic light, and determines when the traffic light displays the red light.

3. The method as described in claim 2, wherein the step (d) comprises:
establishing a mask for identifying whether the traffic light displays the red light according to a size of the red light;
scanning the traffic light image to obtain a scan result according to the mask; and
determining whether the traffic light displays the red light by comparing the scan result with a preset critical value.

4. The method as described in claim 1, wherein the determining step comprises:
setting the stop line as a boundary for traffic violation;
detecting whether a mobile object is at a particular point on the road intersection according to the vehicle data;
upon the condition that the mobile object is at the particular point, detecting whether a moving direction of the mobile object is a direction of entering the road intersection;
upon the condition that the direction of the mobile object is the direction of entering the road intersection, determining whether an image area of the mobile object meets a size of a vehicle;
upon the condition that the image area of the mobile object does meet the size of the vehicle, determining that the mobile object is an offending vehicle that pasts the stop line.

5. The method as described in claim 4, wherein the mobile object detection algorithm is a background subtraction algorithm, an optical flow algorithm, or a temporal differencing algorithm.

6. The method as described in claim 4, wherein the identifying step comprises:
locating a license plate of the offending vehicle using an AdaBoost algorithm or a connectionist model;
separating an image of the license plate from the vehicle data; and
identifying numeric or alphanumeric codes of the license plate from the image of the license plate.

7. The method as described in claim 1, wherein the traffic light illuminates the red light, the green light or a yellow light.

8. An electronic device, comprising:
at least one processor;
a storage system; and
one or more modules that are stored in the storage system and executed by the at least one processor, the one or more modules comprising:
an image obtaining module that controls the at least one image capture device to capture vehicle data at a road intersection, the vehicle data comprising images of a traffic light located at the road intersection;
a traffic light detect module that detects whether the traffic light displays a red light by analyzing the images;
a vehicle violation detect module that determines whether a vehicle pasts a stop line of the road intersection using a mobile object detection algorithm based on the vehicle data, upon the condition that the traffic light displays the red light; and
an identification module that identifies a license number of the vehicle from the vehicle data, and records the license number in the storage system, upon the condition that the vehicle pasts the stop line.

9. The electronic device as described in claim 8, wherein the traffic light detect module detects whether the traffic light illuminates the red light by steps of:
(a) analyzing each of the images and obtaining a traffic light image from the images using a Hue-Saturation-Intensity color model;
(b) setting a threshold value for each color of the traffic light, and dividing the traffic light image into two or three rectangles based on the threshold value for each color of light;
(c) determining whether the two or three rectangles represent the red light, the green light and the yellow light according to juxtapositions of the pixels three rectangles and the proportions of length to width of the two or three rectangles; and
(d) upon the condition that the two or three rectangles represent the red light, the green light, and the yellow light, distinguishing and identifying the red light from the green light and the yellow light according to a color-changing light sequence of the traffic light, and determines when the traffic light displays the red light.

10. The electronic device as described in claim 9, wherein the step (d) comprises:
establishing a mask for identifying whether the traffic light displays the red light according to a size of the red light;
scanning the traffic light image to obtain a scan result according to the mask; and
determining whether the traffic light displays the red light by comparing the scan result with a preset critical value.

11. The electronic device as described in claim 8, wherein the vehicle violation detect module determines whether a vehicle gets across the stop line by steps of:
setting the stop line as a boundary for traffic violation;
detecting whether a mobile object is at a particular point on the road intersection according to the vehicle data;
upon the condition that the mobile object is at the particular point, detecting whether a moving direction of the mobile object is a direction of entering the road intersection;
upon the condition that the direction of the mobile object is the direction of entering the road intersection, determining whether an image area of the mobile object meets a size of a vehicle;
upon the condition that the image area of the mobile object does meet the size of the vehicle, determining that the mobile object is an offending vehicle that pasts the stop line.

12. The electronic device as described in claim 11, wherein the mobile object detection algorithm is a background subtraction algorithm, an optical flow algorithm, or a temporal differencing algorithm.

13. The electronic device as described in claim 11, wherein the identification module identifies the license number of the vehicle by steps of:
locating a license plate of the offending vehicle using an AdaBoost algorithm or a connectionist model;
separating an image of the license plate from the vehicle data; and
identifying numeric or alphanumeric codes of the license plate from the image of the license plate.

14. The electronic device as described in claim 8, wherein the traffic light illuminates the red light, the green light or a yellow light.

15. A non-transitory computer-readable storage medium having stored thereon instructions that, when executed by a processor of an electronic device, causes the processor to perform a vehicle detection method, the method comprising steps of:
controlling the at least one image capture device to capture vehicle data at a road intersection, the vehicle data comprising images of a traffic light located at the road intersection;
detecting whether the traffic light displays a red light by analyzing the images;
determining whether a vehicle pasts a stop line of the road intersection using a mobile object detection algorithm based on the vehicle data, upon the condition that the traffic light displays the red light; and
identifying a license number of the vehicle from the vehicle data, and recording the license number in a storage system of the electronic device, upon the condition that the vehicle pasts the stop line.

16. The storage medium as described in claim 15, wherein the detecting step comprises:
(a) analyzing each of the images and obtaining a traffic light image from the images using a Hue-Saturation-Intensity color model;
(b) setting a threshold value for each color of the traffic light, and dividing the traffic light image into two or three rectangles based on the threshold value for each color of light;
(c) determining whether the two or three rectangles represent the red light, the green light and the yellow light according to juxtapositions of the pixels three rectangles and the proportions of length to width of the two or three rectangles; and
(d) upon the condition that the two or three rectangles represent the red light, the green light, and the yellow light, distinguishing and identifying the red light from the green light and the yellow light according to a color-changing light sequence of the traffic light, and determines when the traffic light displays the red light.

17. The storage medium as described in claim 16, wherein the step (d) comprises:
establishing a mask for identifying whether the traffic light displays the red light according to a size of the red light;
scanning the traffic light image to obtain a scan result according to the mask; and
determining whether the traffic light displays the red light by comparing the scan result with a preset critical value.

18. The storage medium as described in claim 15, wherein the determining step comprises:
setting the stop line as a boundary for traffic violation;
detecting whether a mobile object is at a particular point on the road intersection according to the vehicle data;
upon the condition that the mobile object is at the particular point, detecting whether a moving direction of the mobile object is a direction of entering the road intersection;
upon the condition that the direction of the mobile object is the direction of entering the road intersection, determining whether an image area of the mobile object meets a size of a vehicle;
upon the condition that the image area of the mobile object does meet the size of the vehicle, determining that the mobile object is an offending vehicle that pasts the stop line.

19. The storage medium as described in claim 18, wherein the mobile object detection algorithm is a background subtraction algorithm, an optical flow algorithm, or a temporal differencing algorithm.

20. The storage medium as described in claim 18, wherein the identifying step comprises:
locating a license plate of the offending vehicle using an AdaBoost algorithm or a connectionist model;
separating an image of the license plate from the vehicle data; and
identifying numeric or alphanumeric codes of the license plate from the image of the license plate.
